(19) United States
(12) Patent Application Publication
(10) Pub. No.: US 2019/0338148 A1
(43) Pub. Date: Nov. 7, 2019

(54) Anti-Bacterial Photocatalytic Coated Apparatus

(71) Applicant: Aleddra Inc., Renton, WA (US)

(72) Inventors: Chia-Yiu Maa, Bellevue, WA (US); Chun-Te Yu, Bellevue, WA (US)

(21) Appl. No.: 16/197,343

(22) Filed: Nov. 20, 2018

Related U.S. Application Data
(63) Continuation-in-part of application No. 15/969,987, filed on May 3, 2018.

(51) Int. Cl. C09D 5/16; C09D 5/00; C09D 7/40; C09D 175/04

(52) U.S. Cl. CPC C09D 5/1618; C09D 5/1687; C09D 5/1693; C01G 23/047; C09D 7/67; C09D 175/04; C09D 5/002

(57) ABSTRACT

An anti-bacterial photocatalytic apparatus includes one three dimensional object and one photocatalytic film. The three dimensional object is coated at least partially on the surface with the photocatalytic film. The thickness of the three dimension object underneath the photocatalytic film is at least 20 μm. The transparency of the photocatalytic film is at least 90%, and the thickness of the photocatalytic film is at least 300 nm. Moreover, the photocatalytic film is photocatalytic activated by ambient light with at least 95% of a spectral power distribution (SPD) in the visible light wavelength range greater than 400 nm. When such photocatalytic apparatus is disposed in an indoor environment with normal lighting, the apparatus is photocatalytic activated and can kill the bacteria and the viruses left by people through making contact with the apparatus.

### CROSS REFERENCE TO RELATED PATENT APPLICATION

The present disclosure is a Continuation-in-Part (CIP) of U.S. patent application Ser. No. 15/969,987, the content of which is herein incorporated by reference in its entirety.

### BACKGROUND

### Technical Field

The present disclosure pertains to the field of anti-bacterial photocatalytic devices.

### Description of Related Art

Photocatalysts are known to become active under ultraviolet light and kill bacteria by breaking down the cell wall of the bacteria. Recently technology advancement on photocatalysts has discovered means to activate the anti-bacterial photocatalytic effect with visible light. In U.S. patent application Ser. No. 15/969,987, the inventors applies photocatalytic coating to attachable devices. The attachable photocatalytic device can be attached over the surface of a carrier, thus providing anti-bacterial protection to the carrier. Such attachable anti-bacterial photocatalytic device are suitable for flat surface such as table, computer screen, or even keyboard surface, which is flat, relative speaking. But it would not difficult to use an attachable photocatalytic device to non-flat objects, such as a door knob, or to a very large surface area such as floor. For non-flat objects and large surface areas, it would be more practical to add a photocatalytic coating to the surface of the non-flat object and the floor (or floor tiles) directly.

In U.S. Pat. No. 9,522,384, Lu L. et al. (thereafter “Lu”) teaches the use of a photocatalytic film coated on a carrier in which the photocatalytic film comprises rhombus-shape anatase-type titanium dioxide (TiO₂). Moreover, Lu teaches a coating process through immersing the carrier into a photocatalytic coating liquid. This immersing coating process works as follows: fastening a carrier on a fixture of an elevating device, immersing the carrier into a photocatalytic coating liquid with a descending speed of 5-10 cm/min, elevating the carrier to form a film on the surface of the carrier with an elevating speed of 5-10 cm/min, exposing the carrier to UV lighting for 30 minutes, and drying the carrier with the film at 60-160° C. in an oven.

The immersing coating process taught by Lu has several disadvantages in production process. Firstly, this process can't control accurately the thickness of the photocatalytic film. The photocatalytic film may be too thick or it may be too thin, depending on the wettability and the adhesiveness of the underlying carrier to the photocatalytic coating liquid. If the photocatalytic film is too thick, then it increases the cost of the production due to the use of excessive amount of the expensive photocatalytic material. If too thin, then the photocatalytic film may not provide adequate anti-bacterial protection. Secondly, different types of the carrier, such as glass, ceramic, plastic, or even fabric, have different absorption rate of photocatalytic coating liquid because they differ in their spore density. Coating the carrier through immersing easily leads to a higher absorption rate of the photocatalytic coating liquid on a carrier with more spores, thus resulting a higher production cost in photocatalytic material but without improving the effectiveness of the anti-bacterial protection. Thirdly, the speed of immersing the carrier into the photocatalytic coating liquid and elevating it from the liquid at 5-10 cm/min may be too slow for mass production, thus limiting the production capacity. Fourthly, when immersing a carrier with low density and many spores, such as a thin fabric, into a photocatalytic coating liquid, the photocatalytic particles may saturate the entire fabric, even if the intention is to coat the photocatalytic film only on the surface(s) of the fabric.

An alternative of applying photocatalytic coating liquid is through spraying. With proper control of the spraying process, the four issues with the immersing process as mentioned above can be resolved. Moreover, through experiment of spraying the photocatalytic coating liquid on different substrate materials, the inventors of the present disclosure discovered that each substrate differs in the minimal required usage of the photocatalytic coating liquid for achieving the anti-bacterial effect. When spraying less than the minimal required amount of the photocatalytic coating liquid on a substrate, the photocatalytic film has no anti-bacterial effect. The empirical data on minimal usage of the coating liquid of rhombus-shape anatase-type titanium dioxide for different substrate materials is shown on the table in FIG. 1. A hypothesis may be drawn from the data on the table that the substrate with more spores tends to require a higher minimal usage of the photocatalytic coating liquid. While this may make sense that more spores would naturally absorb more photocatalytic coating liquid, it doesn't explain how much more photocatalytic coating liquid is needed to achieve anti-bacterial effect. Subsequent microscopic examination shows that while different substrates require different minimal usage amount of photocatalytic coating liquid to achieve anti-bacterial effect, the thickness of the photocatalytic film on the surface of the substrate remains remarkably similar across different substrate materials, at about 200-300 nm. It is thus discovered that only after building up adequate thickness of the photocatalytic film on the substrate surface, the photocatalytic film can then generate sufficient free radicals to effectively inhibit and kill the bacteria. Without the minimal adequate thickness, the photocatalytic film can't generate free radicals fast enough to inhibit the bacterial reproduction effectively. Additionally, it is discovered that even on the same substrate, the minimal required usage (hence the thickness) of the photocatalytic coating liquid differs from one bacteria to another. Some bacteria take a longer time to be decomposed by the free radicals than other bacteria, so more free radicals, i.e., thicker the photocatalytic film, are needed for effective killing of these bacteria. FIG. 2 shows the test results of two substrates (polycarbonate and powder-coated aluminum) and two bacteria (E. Coli and Staph. aureus). The photocatalytic coating liquid in use contains >98% net weight in pure water and <1.5% net weight in the rhombus-shape anatase-type titanium dioxide.

As shown in FIG. 2a, for E. Coli, spraying the photocatalytic coating liquid at the amount of 15 g/m² results in effective bacteria inhibition for both substrates. However, as shown in FIG. 2b for Staph. aureus, spraying the same photocatalytic coating liquid at the amount of 25 g/m² still can't effectively inhibit the bacteria. Only after spraying the titanium dioxide liquid at 30 g/m², the results show effectively inhibition of the bacteria on both polycarbonate and the powder coated aluminum substrates. With these findings and further inspection of the photocatalytic coated surfaces, a critical condition is established: for a photocatalytic coated surface to exhibit adequate anti-bacterial behavior, the thickness of the photocatalytic film should be at least 200 nm when using a high density photocatalytic particle such as rhombus-shape anatase-type titanium dioxide. If using a lower density photocatalytic particle, such as sphere-shape anatase-type titanium dioxide, the minimum thickness of the photocatalytic film for effective anti-bacterial effect would be much thicker than 200 nm.

The present disclosure introduces a new anti-bacterial photocatalytic coated apparatus with the construction condition for ensuring the anti-bacterial effectiveness through visible ambient light, as opposed to the use of dedicated (UV) light source. Such device can be used in most indoor environment with normal ambient light source, including sun light, regular lamps, and lighting fixtures.

### SUMMARY

In one aspect, the anti-bacterial photocatalytic coated apparatus comprises one three-dimensional object and one anti-bacterial photocatalytic film. The three dimension object is coated at least partially on its surface with the photocatalytic film. The thickness of the three dimension object coated with the photocatalytic film is at least at least 20 μm for supporting the photocatalytic film. A sheet of fabric or cloth that is 20 μm or more in thickness would meet the definition of a three dimensional object of the present disclosure. The transparency of the photocatalytic film is at least 90%, so that the color and the texture of the underlying three dimensional object remain the same. The thickness of the photocatalytic film is at least 200 nm so as to ensure it can provide adequate anti-bacterial protection when activated by ambient light. Moreover, photocatalytic film is photocatalytic activated by ambient light with at least 95% of a spectral power distribution (SPD) in the visible light wavelength range greater than 400 nm. Therefore, the present disclosure doesn't require dedicated UV light source to activate the photocatalytic film. So long as the ambient light comprising mainly (95% SPD) the visible light wavelength range (>400 nm), the photocatalytic film of the present disclosure is activated. When such photocatalytic apparatus is disposed in an indoor environment with normal lighting, the apparatus is photocatalytic activated and can kill the bacteria and the viruses left by people through making contact with the apparatus. The present disclosure has a great benefit of lowering the infection rate of infectious diseases over a shared device, such as door knob, toilet seat, hand pump dispenser, and floor tiles.

In some embodiments, the main active ingredient of the anti-bacterial photocatalytic film is titanium dioxide (TiO₂). In some other embodiments the main active ingredient is rhombus-shape anatase-type titanium dioxide (TiO₂). As shown in U.S. Pat. No. 9,522,384 by Liu L. et al, the rhombus-shape anatase-type titanium dioxide has a much higher volume density than the sphere-shape anatase-type titanium dioxide, thus it is more effective in the photocatalytic killing of bacteria and viruses.

In some embodiments, the anti-bacterial photocatalytic film may contain at least one other active metal ingredient such as but not limited to, silver, gold, copper, zinc, or nickel. These metals when embedded in the photocatalyst are known to enhance the photocatalytic activity with visible light. Some photocatalytic film may contain more than one type of metals for a better photocatalytic effectiveness.

The titanium dioxide is classified as a semiconducting photocatalyst. Recently technology breakthrough has demonstrated that noble metal nanoparticles such as gold (Au) and silver (Ag) can are a class of efficient photocatalysts working by mechanisms distinct from those of semiconducting photocatalysts (https://pubs.rsc.org/en/content/articlelanding/2013/gc/c3gc40450a#!divAbstract). The present disclosure is not limited to the use of semiconducting photocatalysts. In some embodiments, the main active ingredient of the anti-bacterial photocatalytic film is a noble metal nanoparticle comprising gold (Au) or sliver (Ag).

Some three dimension material such as non-woven fabric may form a strong binding with a photocatalytic film, while other three dimensional material such metal knob or glass window may not form a strong binding with a photocatalytic film. In the latter case, the photocatalytic film coated on the three dimensional object may be easily scrubbed off. Therefore, in some embodiments of the present disclosure, a prime coating film is disposed between the three dimensional object and the anti-bacterial photocatalytic film, and the prime coating has at least 90% light transparency.

Having a prime coating prior on the three dimensional object adds one more step to the production with a consequence of increased production cost. An alternative is to intermix the photocatalytic particles with the prime coating first, and then use the mixed coating material to coat the three dimensional object. Therefore, in some embodiments of the present disclosure, a prime coating material with at least 90% light transparency is intermixed with the photocatalytic particles. In some embodiments, the prime coating material to be intermixed with the photocatalytic particles comprises waterborne polyurethane dispersion (PUD) or waterborne polyurethane acrylate (PUA). PUD and PUA are waterborne in nature, and are suitable for mixing with water-based photocatalytic coating liquid.

In some embodiments, the photocatalytic film is coated onto the three dimension object through spraying of water-based photocatalytic coating liquid comprising at least 95% net weight in water and less than 5% of net weight in photocatalytic particles.

In some other embodiments, the photocatalytic film is coated onto the three dimension object through immersing the object into water-based photocatalytic coating liquid comprising at least 95% net weight in water and less than 5% of net weight in photocatalytic particles. Spraying is more suitable for coating large flat surface area, such as tiles for window. Immersing is more suitable for non-float surface area such as door knob. Dipping, another form of immersing, is more suitable for coating an extruded portion of the three dimensional object, such as the top of a hand-pump that makes the most contact with user's hand.

In some embodiments, the coating of the photocatalytic film, through either spraying or immersion, is followed by baking the three dimension object at a temperature greater than 50 degree Celsius for at least 5 minutes. Baking, which is one kind of curing process for enhancing the binding of the photocatalytic film with the three dimensional object or the prime coating, thus preventing the photocatalytic film from being scrubbed off the three dimensional object. The temperature and the duration of the baking varies from the surface material of the three dimensional object. It is foreseeable that other form of curing, such as natural curing, UV lighting curing, may be used instead of baking.

The table in FIG. 3 shows the results of scrubbing test on two TiO₂ coated substrates: polycarbonate and powder coated aluminum. With polycarbonate, a baking process at 190° C. for 20 minutes is used. With the scrubbing of a 500 g object, the TiO₂ film remains intact after 20 scrubs, but it gets scrubbed off after 30 scrubs. With powder coated aluminum, a baking process at 100° C. for 20 minutes is used. With the scrubbing of a 500 g object, the TiO₂ film remains intact after 350 scrubs, but it gets scrubbed off after 400 scrubs. The results show the TiO₂ film can form a very strong binding to the powder coated aluminum substrate, as compared to that of the polycarbonate substrate. For TiO₂ to form a stronger biding with polycarbonate, a prime coating material such as PUD may be used to mix with TiO₂ first before applying onto the polycarbonate surface and followed by baking.

With the present disclosure, there is no restriction on the shape, size, or material on the three dimensional object, other than it has a minimum thickness of 20 μm. Moreover, the three dimensional object may be rigid, soft, or flexible.

### BRIEF DESCRIPTION OF THE DRAWINGS

The accompanying drawings are included to aid further understanding of the present disclosure, and are incorporated in and constitute a part of the present disclosure. The drawings illustrate a select number of embodiments of the present disclosure and, together with the detailed description below, serve to explain the principles of the present disclosure. It is appreciable that the drawings are not necessarily to scale, as some components may be shown to be out of proportion to size in actual implementation in order to clearly illustrate the concept of the present disclosure.

FIG. 1 lists in a table the minimal usage of rhombus-shape anatase-type titanium dioxide coating liquid for different substrate materials with anti-bacterial effect.

FIG. 2a lists in a table the test result of spray-coating the rhombus-shape anatase-type titanium dioxide coating liquid on polycarbonate and powder coated aluminum substrates with E. Coli bacteria.

FIG. 2b lists in a table the test result of spray-coating the rhombus-shape anatase-type titanium dioxide coating liquid on polycarbonate and powder coated aluminum substrates with Staph. aureus bacteria.

FIG. 3 lists in a table the scrubbing test results of polycarbonate and powder coated aluminum substrates after coating with the same amount of rhombus-shape anatase-type titanium and the heat-dried at different temperatures.

FIG. 4 schematically depicts a diagram of anti-bacterial metal door knob.

FIG. 5 schematically depicts a diagram of anti-bacterial toilet seat.

FIG. 6 schematically depicts a diagram of anti-bacterial hand-pump dispenser.

FIG. 7 schematically depicts a diagram of anti-bacterial another dispenser.

### DETAILED DESCRIPTION OF PREFERRED EMBODIMENTS

### Overview

Various implementations of the present disclosure and related inventive concepts are described below. It should be acknowledged, however, that the present disclosure is not limited to any particular manner of implementation, and that the various embodiments discussed explicitly herein are primarily for purposes of illustration. For example, the various concepts discussed herein may be suitably implemented in a variety of lighting apparatuses having different form factors.

### EXAMPLE IMPLEMENTATIONS

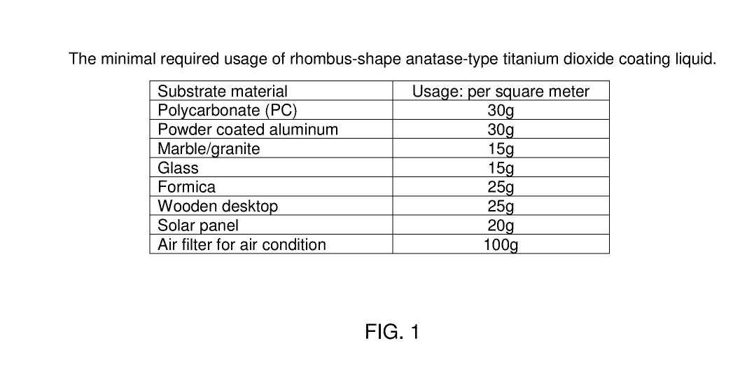

The FIG. 1 is an embodiment of the anti-bacterial photocatalytic coated apparatus of the present disclosure in a form of a metal door knob 100. By nature, the surface of the metal door knob 101 doesn't has spores, so it can't form strong binding with a water-based photocatalytic coating liquid. So a prime coating material polyurethane dispersion (PUD) 102 with a strong adhesiveness to metal is applied on the surface of the metal door knob first, and then a photocatalytic film 103 is coated over the prime coating film. The applying of the priming coating film and the photocatalytic film may be through spraying or immersion. The photocatalytic coating liquid is applied over the PUD prime coating film before the PUD material is completely dry up. A baking process may be used after applying the photocatalytic coating liquid to ensure a binding with the surface of the metal door knob. The thickness of the PUD prime coating film 300-400 nm. The thickness of the photocatalytic film is at least 200 nm in order to guarantee the effectiveness of the bacteria killing effect. Both the prime coating film 102 and photocatalytic film 103 are transparent, so they don't change the color and the textile of the underlying surface of the metal door knob. The photocatalytic film 103 may be activated by an ambient light source, such as incandescent light, fluorescent light, LED light, halogen light, or any similar light source with at least 95% of a spectral power distribution (SPD) in the visible light wavelength range greater than 400 nm. The bacteria and the viruses left on the surface of this door knob by user's hands would be killed and decomposed by the photocatalytic film 103. This anti-bacterial photocatalytic coated door knob doesn't require dedicated (UV) light source to activate the photocatalytic activity.

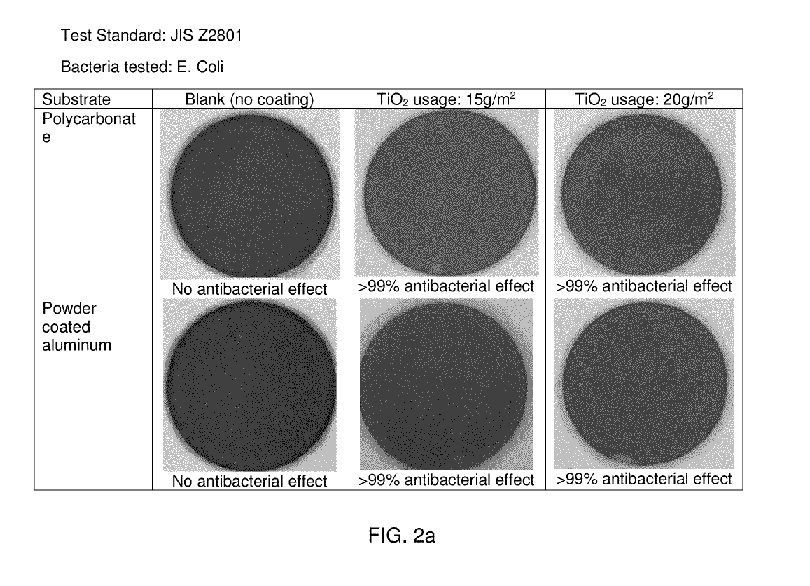

The FIG. 2 is another embodiment of the anti-bacterial photocatalytic coated apparatus of the present disclosure in a form of a toilet 200. A water-based photocatalytic coating liquid with rhombus-shaped anatase-type titanium dioxide (TiO₂) is mixed with a waterborne prime coating material polyurethane dispersion (PUD) first, and then coated on the surface of the toilet seat 201, resulting a coating film 202 of TiO₂ and PUD with a thickness of 500-600 nm. The mixed coating film 202 of TiO₂ and PUD can be photocatalytic activated by the ambient light source in the bathroom since incandescent light, fluorescent light, LED light, or halogen light all have at least 95% of a spectral power distribution (SPD) in the visible light wavelength range greater than 400 nm. The bacteria and the viruses left on the surface of this toilet seat through physical contact of a user would be killed and decomposed by the mixed coating film 202 of TiO₂ and PUD, thus prevent the transmission of an infectious disease from the skin of one user to the next.

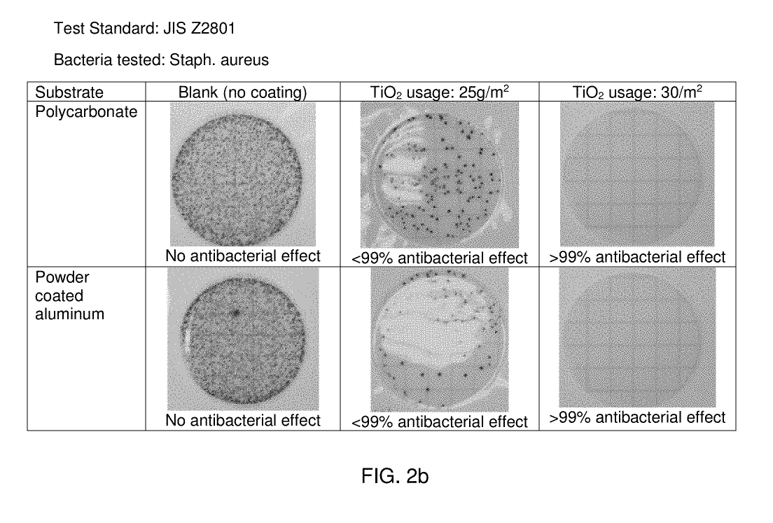

The FIG. 3 is another embodiment of the anti-bacterial photocatalytic coated apparatus of the present disclosure in a form of a hand pump dispenser 300. A water-based photocatalytic coating liquid with rhombus-shaped anatase-type titanium dioxide (TiO₂) is mixed with a waterborne prime coating material polyurethane dispersion (PUD) first, and then coated on the surface of the hand pump dispenser 301, through dipping the dispenser into the mixed coating film 302 of TiO₂ and PUD. The thickness of the mixing coating film 302 of TiO₂ and PUD may be around 300-400 nm. After dipping, a baking process may be used on the hand pump dispenser 300 for forming a strong binding of the mixed photocatalytic coating film 302 with the surface of the hand pump dispenser 301 so as to withstand the constant rubbing of the dispenser surface through its normal use. The mixed coating film 302 of TiO₂ and PUD can be photocatalytic activated by the ambient light source with at least 95% of a spectral power distribution (SPD) in the visible light wavelength range greater than 400 nm. The bacteria and the viruses left on the surface of this hand pump dispenser through physical contact of a user would be killed and decomposed by the mixed coating film 302 of TiO₂ and PUD.

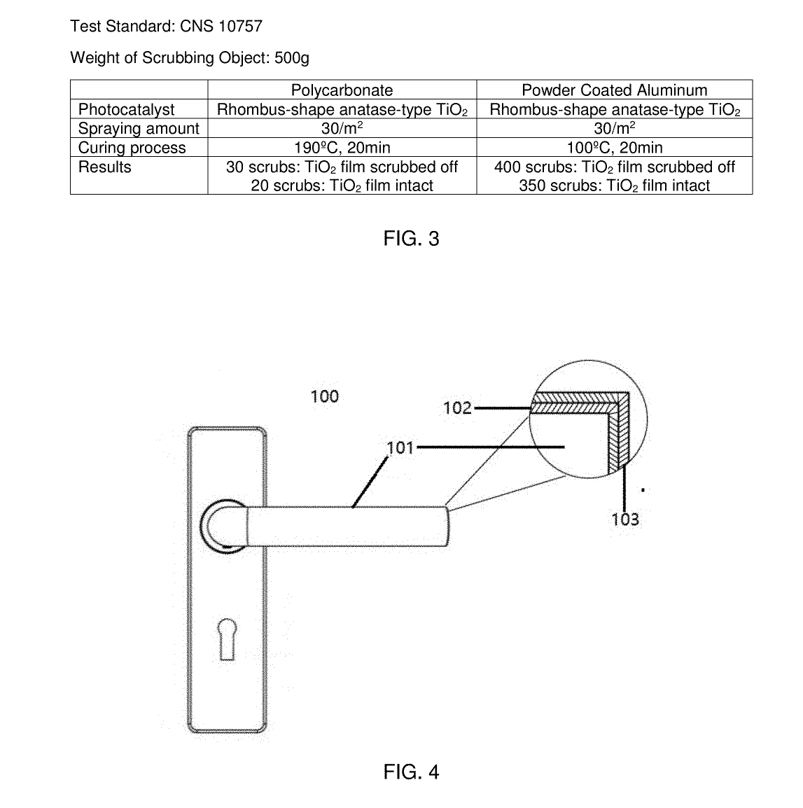

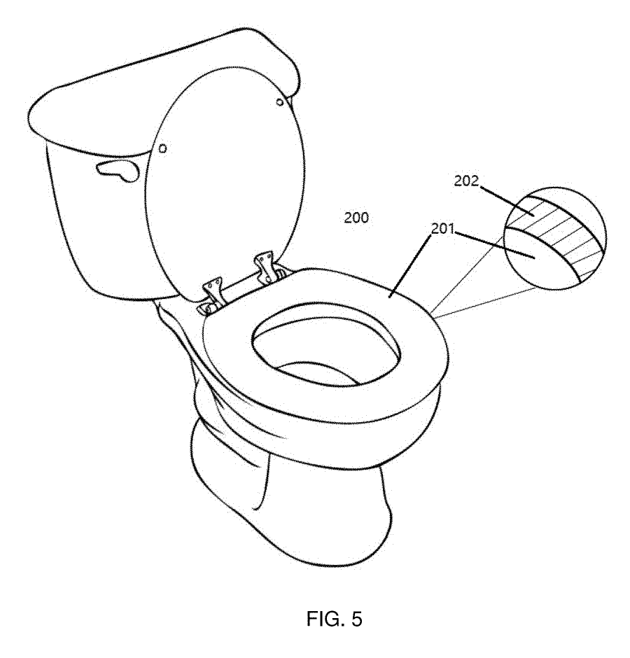

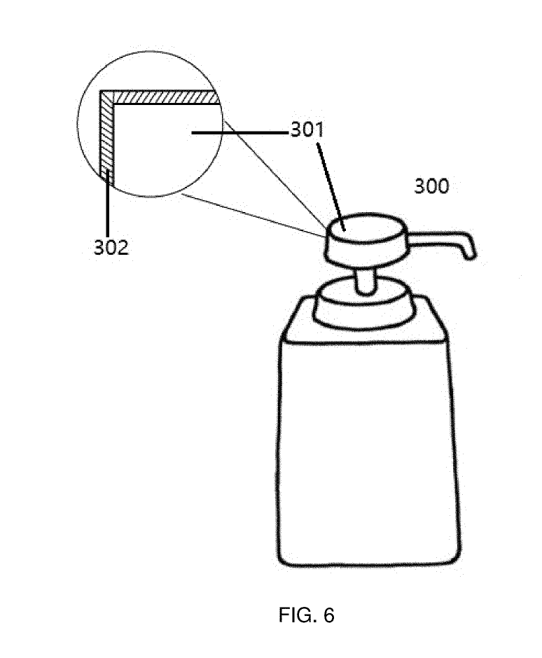

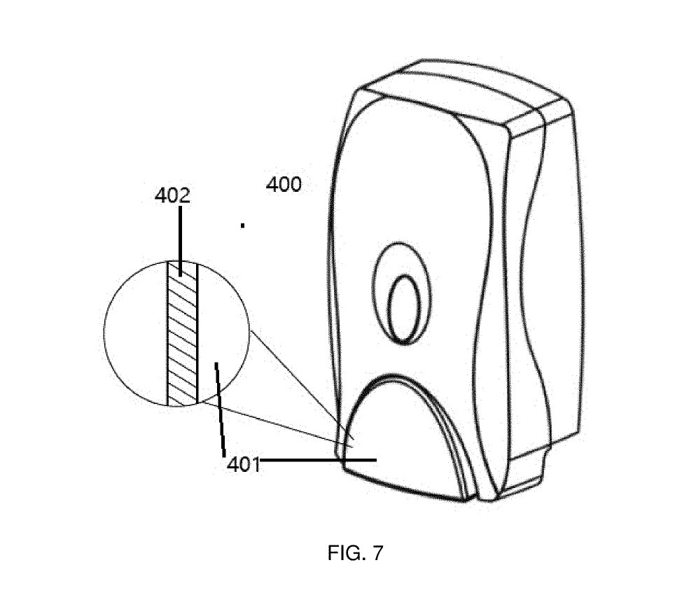

The FIG. 4 is another embodiment of the anti-bacterial photocatalytic coated apparatus of the present disclosure in a form of a liquid dispenser 400. A water-based photocatalytic coating liquid with rhombus-shaped anatase-type titanium dioxide (TiO₂) is mixed with a waterborne prime coating material polyurethane dispersion (PUD) first, and then coated on the surface of the dispenser 401 through spraying. The thickness of the mixing coating film 402 of TiO₂ and PUD may be around 300-400 nm. After spraying, a baking process may be used on the hand pump dispenser 400 for forming a strong binding of the mixed photocatalytic coating film 402 with the surface of the hand pump dispenser 401 so as to withstand the constant rubbing of the dispenser surface through its normal use. The mixed coating film 402 of TiO₂ and PUD can be photocatalytic activated by the ambient light source with at least 95% of a spectral power distribution (SPD) in the visible light wavelength range greater than 400 nm. The bacteria and the viruses left on the surface of this dispenser through physical contact of a user would be killed and decomposed by the mixed coating film 402 of TiO₂ and PUD. For dispenser type of device, it is not necessary to coat the whole surface with the photocatalytic film. It suffices to have photocatalytic film on the “touch points” of the dispenser, i.e., the areas where that are most touched when in use.

### Additional and Alternative Implementation Notes

Although the techniques have been described in language specific to certain applications, it is to be understood that the appended claims are not necessarily limited to the specific features or applications described herein. Rather, the specific features and examples are disclosed as non-limiting exemplary forms of implementing such techniques.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

What is claimed is:

1. An anti-bacterial photocatalytic coated apparatus, comprising:
a three-dimensional object; and
an anti-bacterial photocatalytic film,
wherein:
the three-dimension object is coated at least partially on a surface with the anti-bacterial photocatalytic film,
a transparency of the anti-bacterial photocatalytic film is at least 90%,
a thickness of the anti-bacterial photocatalytic film is at least 300 nm,
a thickness of the three-dimension object underneath the anti-bacterial photocatalytic film is at least 20 μm, and
the anti-bacterial photocatalytic film is photocatalytic activated by ambient light with at least 95% of a spectral power distribution (SPD) in a visible light wavelength range greater than 400 nm.

2. The anti-bacterial photocatalytic coated apparatus of claim 1, wherein a main active ingredient of the anti-bacterial photocatalytic film comprises titanium dioxide (TiO₂).

3. The anti-bacterial photocatalytic coated apparatus of claim 2, wherein the main active ingredient comprises rhombus-shaped anatase-type titanium dioxide (TiO₂).

4. The anti-bacterial photocatalytic coated apparatus of claim 1, wherein the anti-bacterial photocatalytic film contains at least one other active metal ingredient comprising silver, gold, copper, zinc, nickel, or a combination thereof.

5. The anti-bacterial photocatalytic coated apparatus of claim 1, wherein a main active ingredient of the anti-bacterial photocatalytic film comprises a noble metal nanoparticle comprising gold (Au) or sliver (Ag).

6. The anti-bacterial photocatalytic coated apparatus of claim 1, wherein a prime coating film is disposed between the three-dimensional object and the anti-bacterial photocatalytic film, and wherein the prime coating film has at least 90% light transparency.

7. The anti-bacterial photocatalytic coated apparatus of claim 1, wherein a prime coating material with at least 90% light transparency is intermixed with photocatalytic particles of the anti-bacterial photocatalytic film.

8. The anti-bacterial photocatalytic coated apparatus of claim 7, wherein the prime coating material comprises waterborne polyurethane dispersion (PUD) or waterborne polyurethane acrylate (PUA).

9. The anti-bacterial photocatalytic coated apparatus of claim 1, the anti-bacterial photocatalytic film is coated onto the three-dimension object through spraying of a water-based photocatalytic coating liquid comprising at least 95% of net weight in water and less than 5% of net weight in photocatalytic particles.

10. The anti-bacterial photocatalytic coated apparatus of claim 9, wherein a coating of the anti-bacterial photocatalytic film is followed by baking the three-dimension object at a temperature greater than 50 degree Celsius for at least 5 minutes.

11. The anti-bacterial photocatalytic coated apparatus of claim 1, the anti-bacterial photocatalytic film is coated onto the three-dimension object through immersing the three-dimension object into a water-based photocatalytic coating liquid comprising at least 95% of net weight in water and less than 5% of net weight in photocatalytic particles.

12. The anti-bacterial photocatalytic coated apparatus of claim 11, wherein a coating of the anti-bacterial photocatalytic film is followed by baking the three-dimension object at a temperature greater than 50 degree Celsius for at least 5 minutes.

13. The anti-bacterial photocatalytic coated apparatus of claim 1, wherein the three-dimensional object is of any shape, size, or material, and is rigid, soft, or flexible.
